(19) United States
(12) Patent Application Publication
(10) Pub. No.: US 2008/0048005 A1
(43) Pub. Date: Feb. 28, 2008

(54) FRICTION STIR WELDING SYSTEM AND METHOD

(76) Inventors: Mariana G Forrest, Troy, MI (US); Feng Lu, Farmington Hills, MI (US); Stephen D. Logan, Northville, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/466,875

(22) Filed: Aug. 24, 2006

(51) Int. Cl. A47J 36/02

(52) U.S. Cl. 228/101

(57) ABSTRACT

A friction stir welding method where a friction stir welding device is moved through a plurality of points that form an essentially conical shape as the device engages substrates to be welded to form a mechanical interlocking structure at an interface between the substrates.

### FIELD

The present teachings relate to methods for friction stir welding a plurality of substrates, as well as to a friction stir welding device.

### BACKGROUND

As automotive technology has advanced, there has become a need for materials that are lightweight yet high in strength. In pursuit of this, vehicle weight reduction requirements are expected to drive the application and development of using materials formed of Aluminum and Magnesium in automotive body construction. As these materials come into use, however, it is becoming increasingly difficult to find ways to join these materials together by welding. Friction stir welding technology is a process currently used to join some of these materials together.

In friction stir spot welding, a device including a rotating pin or probe enters the sheets to be welded and uses frictional forces generated between the pin and the substrates to plasticize and join the substrates. This method, however, has a limitation in that it is difficult to join metallurgically mismatched material stack-ups. That is, friction stir welding technology is very proficient at joining the same materials (e.g., aluminum to aluminum) together, but is insufficient to join dissimilar materials together (e.g., aluminum to magnesium). Even for similar material stack-ups, this method is not proficient when the stack-up contains more than two layers, and when the substrates have dissimilar thicknesses, especially when the thin substrate is on top. Accordingly, there remains a need for an improved friction stir welding process.

### SUMMARY

In view of the drawbacks of the prior art friction stir welding methods, the present teachings provide a method where a friction stir welding device is engaged to a pair of substrates, and the friction stir welding device is moved through a plurality of points that form an essentially conical shape as the device engages the substrates. The present teachings also provide a method where a plurality of friction stir welding devices are engaged to a pair of substrates, and at least one friction stir welding device has a diameter that is larger than a diameter of the other friction stir welding devices. Additionally, the present teachings provide a method where a friction stir welding device is engaged to a pair of substrates, and the friction stir welding device is moved through a substantially spiral path away from a point where the device initially engaged the substrates as the devices engages the substrates. Each of these methods is proficient at forming a mechanical interlocking structure at an interface between the substrates.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present teachings will become more fully understood from the detailed description and the accompanying drawings, wherein:

FIGS. 1A and 1B are schematic representations of a friction stir spot welding method according to the present teachings;

FIG. 2 is a cross-sectional view of a pair of substrates joined according to the present teachings;

FIG. 3 is a top view schematically showing the orientation of a pair of friction stir welding devices as the devices move in a welding direction;

FIG. 4 is a cross-sectional view of a pair of substrates joined according to the present teachings;

FIG. 5 is a top view schematically showing the orientation of a plurality of friction stir welding devices as the devices move in a welding direction;

FIGS. 6A and 6B are a top view and cross-sectional view of a friction stir welding method according to the present teachings and a pair of substrates joined according to the present teachings, respectively;

FIG. 7 is a schematic representation of a friction stir welding device according to the present teachings;

FIG. 8 is another schematic representation of another friction stir welding device according to the present teachings; and

FIG. 9 is a schematic representation of an anvil that may be used in conjunction with the friction stir welding methods according to the present teachings; and

FIG. 10 is a schematic representation of another friction stir welding method according to the present teachings.

### DETAILED DESCRIPTION

The following description of the preferred embodiments is merely exemplary in nature and is in no way intended to limit the present teachings, their application, or uses.

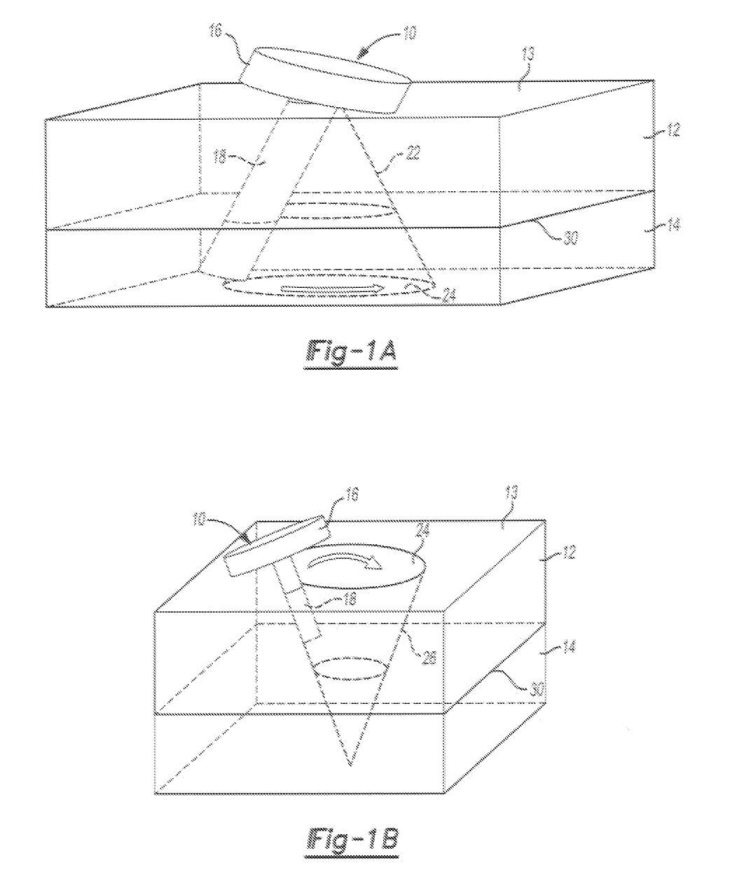

Referring to FIGS. 1A and 1B, the friction stir spot welding method according to the present teachings will now be described. As shown in FIGS. 1A and 1B, a friction spot welding device 10 is engaging a pair of substrates 12 and 14 to be welded together. The friction spot welding device 10 includes a shoulder 16 and a pin 18. In joining the substrates 12 and 14 together, the device 10 is rotated in either a clockwise or counterclockwise direction at high revolutions per minute (RPM).

In accordance with the method of the present teachings, the device 10, in addition to being rotated at high RPM, has its orientation changed relative to the substrates 12 and 14. In this regard, the device 10 is tilted and moved relative to the substrates 12 and 14 through a plurality of points that is essentially a conical shape 22.

As shown in FIG. 1A, as the device 10 engages the substrates 12 and 14, the device 10 is tilted such that the pin 18 is swept through a plurality of points that form a base 24 of the conical shape 22. By tilting and sweeping the device 10 in this manner, plasticized material of the substrates 12 and 14 generated by the frictional forces between the rotating device 10 and the substrates 12 and 14 is forced or pushed to positions outside of the conical shape 22. Where the plasticized material is pushed outside of the conical shape 22 is dependent on a number of parameters, including tool design and motion patterns and directions. Regardless, by tilting and sweeping the device 10 as the device 10 rotates, the plasticized material is generally forced and pushed toward an upper surface 13 of the substrate 12, where an annular protrusion of the plasticized material is generated. Further, the upper substrate 12, within the area bounded by the annular protrusion experiences thinning which is undesirable because it may lead to lower strength of the joint between the substrates 12 and 14. This thinning problem is also known as a limitation/disadvantage of the prior art.

To eliminate, or at least substantially diminish, the thinning of the substrate 12, the device 10 is again engaged to the substrates 12 and 14. The device 10, however, is now tilted and moved relative to the substrates 12 and 14 through a plurality of points that forms an inverse conical shape 26. By tilting and sweeping the device 10 in this manner, plasticized material of the substrates 12 and 14 generated by the frictional forces between the rotating device 10 and the substrates 12 and 14 is forced or pushed to positions inside of the conical shape 26. In other words, the annular protrusion of plasticized material that was initially pushed outside of the conical shape 22 shown in FIG. 1A to an upper surface 13 of the substrate 12 is pushed back toward the central hole generated by the device 10. In this manner, any thinning of the substrate 12 where the device 10 initially engaged the substrate 12 is eliminated, or at least substantially diminished. By eliminating the thinning section of the substrate 12, the substrates 12 and 14 can be more robustly joined together.

It should be understood that, in addition to eliminating the thinning section of the substrate 12 where the device 10 initially engaged the substrate 12, the movement of the device 10 through the plurality of points that is conical in shape also results in a more robust joining of the substrates 12 and 14 because, as shown in FIG. 1A, the pin 18 of the device initially engages a larger surface area (i.e., the base 24 of the conical shape 22) of the second substrate 14. Subsequently, when the device 10 is moved through the plurality of points that results in the inverse conical shape 26, the pin engages a larger surface area (i.e., the base 24 of the inverse conical shape 26) of the first substrate 12. In this manner, both substrates 12 and 14 are engaged in approximately equal amounts which results in a more robust and stronger joining of the substrates 12 and 14. That is, the amount of material (i.e., volume of material) that is bonded is greater around the pin 18 exit hole.

Moreover, it should be understood that thinning of the substrate 12 is also avoided by the cone stir method of the present teachings because the shoulder 16 of the device 10 is not required to sink into the upper substrate 12 before pin 18 withdrawal. More particularly, according to prior art friction stir spot welding methods, a friction stir spot welding device is engaged to the substrates orthogonally. To fully engage the lower substrate and sufficiently join the upper and lower substrates together, the shoulder of the device was required to sufficiently penetrate (or sink into) the upper substrate. This penetration of the shoulder into the upper substrate causes unnecessary thinning of the upper substrate, which as stated above, results in a poor joint between the substrates. The present teachings eliminate, or at least substantially diminish, this thinning by not requiring penetration of the shoulder 16 of the device 10 into the substrate 12 just before pin 18 withdrawal. Further, as described above, the tilting and sweeping of the device 10 through the cone 22 and inverse cone 26 increases the amount of plasticized material between the substrates 12 and 14, as well as returns it to generally its original position. In this manner, a more robust joint is achieved between the substrates 12 and 14.

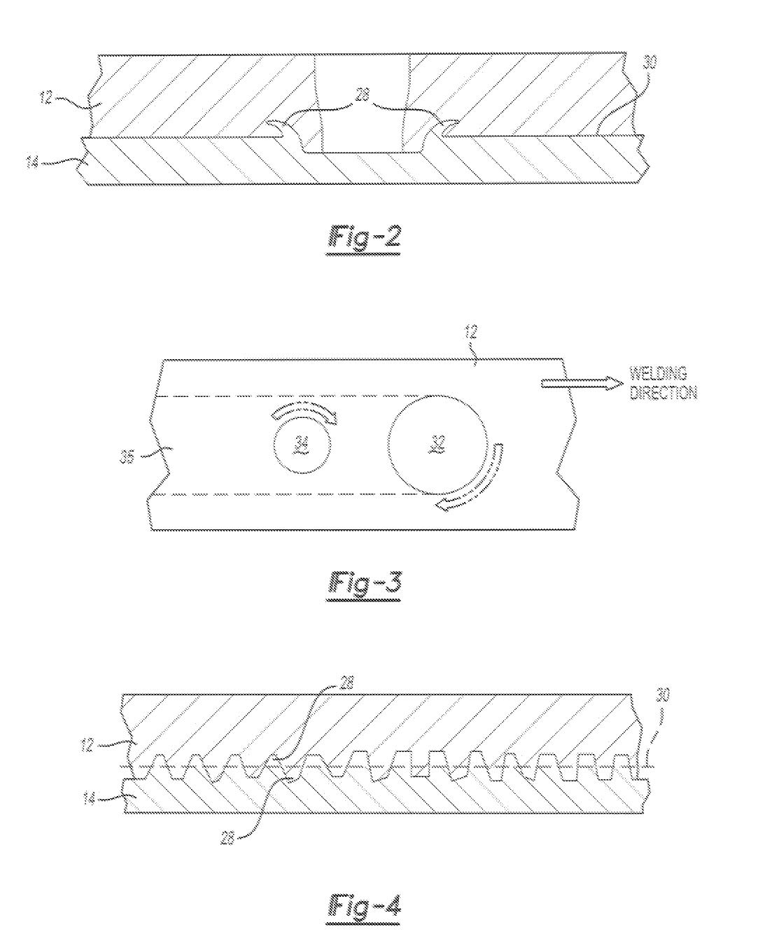

Furthermore, by properly manipulating the process parameters such as the size of the conical-shaped surfaces 22 and 26 that the friction spot welding device 10 is swept through, a cone angle, RPM, an amount of time the device 10 is engaged with the substrates 12 and 14 etc., a mechanical structure can be generated between the first and second substrates 12 and 14. More specifically, now referring to FIG. 2, it can be seen that by sweeping the friction spot welding device 10 through the plurality of points that formed the conical shaped 22 and 26, an annular collar-shaped interlock structure 28 of material from the bottom substrate 14 is generated at the interface 30 between the substrates 12 and 14. This interlock 28 looks similar to hooks that secure the substrates 12 and 14 together when viewed in cross-section.

The collar-shaped interlock 28 results in a mechanical inter-lock between the substrates 12 and 14. That is, as stated above, the collar-shaped interlock 28 between the substrates 12 and 14 substantially “hooks” the substrates 12 and 14 mechanically together with a surprising amount of strength. More particularly, referring to Table 1 below, it can be seen that the joint strength achieved by sweeping the device 10 through a conical shape 22 and 26 according to the friction stir spot welding process according to the present teachings results in a maximum load strength that is approximately twice as strong as those found in prior art friction stir spot welding methods (i.e., where the device 10 merely engages the substrates 12 and 14 orthogonally).

Maximum Load

| Specimen | (lbs) | (N) |
|---|---|---|
| Example 1 | 537 | 2390 |
| Example 2 | 450 | 2003 |
| Example 3 | 482 | 2145 |
| Comparative example 1 | 275 | 1224 |
| Comparative example 2 | 275 | 1224 |
| Comparative example 3 | 225 | 1001 |
| Comparative example 4 | 250 | 1113 |

The generation of the collar-shaped interlock 28 is particularly advantageous when joining substrates 12 and 14 that are formed of dissimilar materials. That is, as stated above, friction stir spot welding methods are generally advantageous when joining substrates 12 and 14 that are formed of the same material. In this regard, preferable substrates include materials such as steel, aluminum, magnesium, etc. Orthogonally engaging the substrates 12 and 14 with the device 10, however, is not particularly advantageous when joining substrates 12 and 14 formed of metallurgically mismatched materials. For example, it is particularly difficult to join an aluminum substrate to a magnesium substrate. Notwithstanding, by tilting and sweeping the device 10 through a plurality of positions that are essentially conical-shaped, substrates 12 and 14 formed of dissimilar materials can be joined together more easily with a strong joint, regardless of the bonding nature between the materials. Accordingly, an aluminum substrate can be joined to a magnesium substrate.

The present teachings should not be limited to merely joining aluminum substrates to magnesium substrates. On the contrary, the present teachings are applicable to joining any combination of substrates selected from materials such as, without limitation, steel, stainless steel, aluminum (Al), magnesium (Mg), tungsten (W), titanium (Ti), cobalt (Co), silver (Ag), copper (Cu), brass, bronze, Fe-Austenite, nickel (Ni), platinum (Pt), platinum iridium (Pt—Ir), chromium (Cr), iridium (Ir), Fe-Martensite, molybdenum (Mo), niobium (No), tantalum (Ta), and other difficult-to-weld alloys such as Inconel, Monel, and nickel-based (Ni) superalloys. In addition, although only a pair of substrates 12 and 14 are shown in FIGS. 1A, 1B, and 2, it should be understood that the present teachings enable joining more than two layers in a stack-up. That is, a plurality of substrates may be bonded together using the present teachings. Further, the plurality of substrates may each be formed of a different material. Finally, the tilting of the pin 18 results in a larger extent of the shoulder 16 being in engagement with the substrate surface, which may relax the requirement for rigid clamping using fixtures to connect the substrates 12 and 14 during welding.

The substrates 12 and 14 can be joined in an unheated state. The substrates 12 and 14, however, may also be pre-heated or heated simultaneously when being engaged by the device 10. In this regard, heating of the substrates 12 and 14 further enables easier plastic deformation and, hence, the formation of the interlock 28 at the interface 30 between the substrates 12 and 14. This is a result of an improved ductility of the substrates 12 and 14 when the substrates 12 and 14 are heated, and is also a result of the substrates 12 and 14 being plastically deformed during the welding process.

In addition to the friction stir spot welding method, and as an alternative to heating the substrates 12 and 14, the present teachings also provide a linear stitch friction stir welding method that utilizes a dual pin concept. That is, referring to FIG. 3, the dual pin concept of the present teachings employs a pair of friction stir welding devices 32 and 34 in tandem configuration. In this method, the leading or first device 32 only penetrates the top substrate 12 as the leading device 32 moves in the welding direction. During penetration of the upper substrate 12, the pin (not shown) of the device 32 heats and increases ductility of the upper substrate 12, and plastically deforms it. Subsequently, the trailing device 34 follows the leading device 32 in the welding direction. Preferably, the trailing device 34 should be smaller in diameter than the leading device 32 so that it falls within the width of the plasticized material 35 of the upper substrate 12 created by the leading device 32. In this manner, the plasticized material 35 of the upper substrate 12 is more easily commingled with the material of the lower substrate 14, which results in a stronger bond between the substrates 12 and 14.

Contrary to the leading device 32, the trailing device 34 penetrates the pair of substrates 12 and 14 at the interface 30 between the substrates to create the desired bonding structure. That is, the trailing device 34 should penetrate the substrate interface 30 to form the desired mechanical locking structure (FIG. 4). The desired locking structure between the substrates 12 and 14 occurs because, as stated above, the leading device 32 plasticizes the material of the upper substrate 12. In addition, the leading device 32 may be configured with an optimized pin design and direction of rotation that pushes the material down towards the second, lower substrate 14. In contrast, the trailing device 34 may be configured with another optimized pin design and direction of rotation that is able to pull the material of both the upper and lower substrates 12 and 14 upwards toward the upper substrate 12.

By controlling the flow of the material of the substrates 12 and 14 with the leading and trailing devices 32 and 34, the substrates 12 and 14 can have an interlocking joint structure that runs along the direction of the weld. This structure, as shown in FIG. 4, is similar to the interlocking structure achieved using the conical shaped plurality of points described above. Referring to FIG. 4, it can be seen that by using the tandem of friction stir welding devices 32 and 34, a plurality of interlocks 28 can be formed along the entire length of the weld between the substrates 12 and 14. By forming a plurality of these interlocks 28 along the length of the weld, the substrates 12 and 14 can be more robustly joined.

In addition, formation of the interlocks 28 can be optimized by controlling the inter-device distance, RPM, rotating direction of each device, pin geometries, and thread orientation. That is, the present teachings enable synchronized material motion/flow between the two devices 32 and 34 to generate certain patterns that would not be possible with a single device. For example, although the leading and trailing devices 32 and 34 are shown to be rotating in the same direction (here a clockwise direction), it should be understood that the devices 32 and 34 may be rotated in a counter-clockwise direction. Or the leading and trailing devices 32 and 34 may be rotated in opposite directions. That is, at least one of the leading and trailing devices 32 and 34 may be rotated in a clockwise direction and the other of the leading and trailing devices 32 and 34 may be rotated in a counter-clockwise direction. Accordingly, the flow of plasticized material 35 of the substrates 12 and 14 can be tailored according to a specific application.

Moreover, although the leading and trailing devices 32 and 34 are shown in line with one another, the present teachings should not be limited thereto. That is, the trailing device 34 can be offset from the leading device 32 such that the trailing device 34 travels along an axis that runs parallel to an axis that is concentric with a center of the leading device in the weld direction on which the leading device 32 travels. Further, although preferable, the trailing device 34 does not have to travel behind the leading device 32. In this regard, the trailing device 34 may travel side-by-side with the leading device 32 without departing from the spirit and scope of the present teachings.

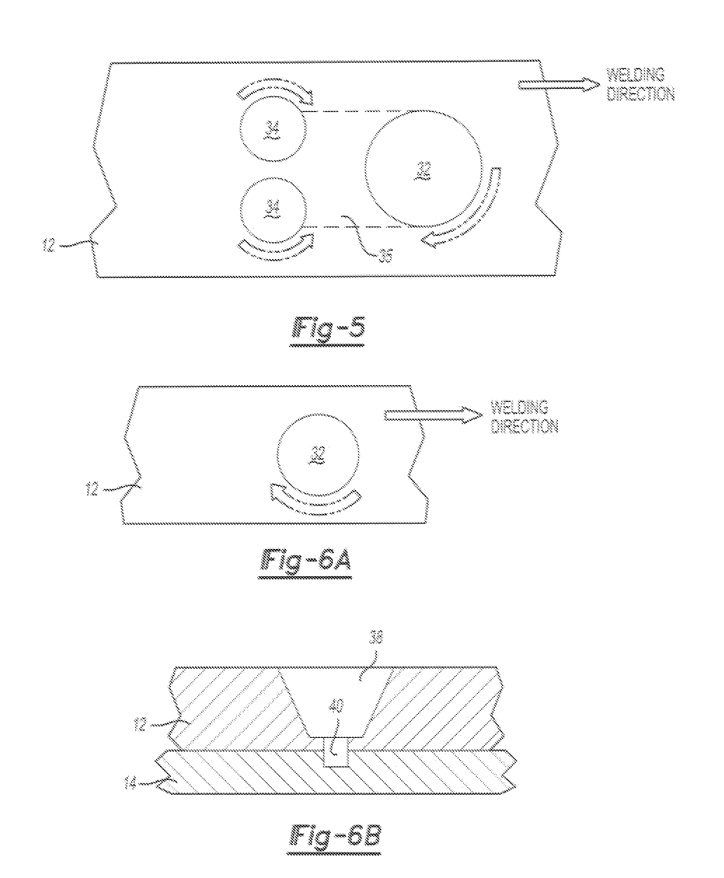

Also, more than two devices may be used. Referring to FIG. 5, a configuration including a larger pin diameter machine 32 in front, with two side-by-side smaller diameter pin machines 34 in the rear may be used. This is a so-called triple pin process. Although FIG. 5 depicts a larger diameter pin as the leading pin 32, and two smaller diameter pins as the trailing pins 34, it should be understood that any combination of the three pins may be utilized. That is, the two smaller diameter devices may be used as leading devices while the larger diameter device is used as the trailing device. Regardless, it should be understood that it is preferable that the leading device(s) 32 only engage the upper substrate 12 to plasticize the upper substrate 12. Furthermore, it should be understood that although the two trailing devices 34 are shown to rotate in the opposite directions, each of the trailing devices 34 may be rotated in the same direction as well. Moreover, the three devices may be rotating in the same direction, or the three devices may be rotating in different directions. Lastly, it should be understood that the devices used may use threaded pins, unthreaded pins, and combinations thereof; and each device may also have a pin 18 that has a different thread from the other devices. Regardless, any parameter such as pin size, pin threading, shoulder size, angle of the pin, RPM of each pin, angle of engagement to the substrates, etc. may be adjusted to accommodate any application known to one skilled in the art.

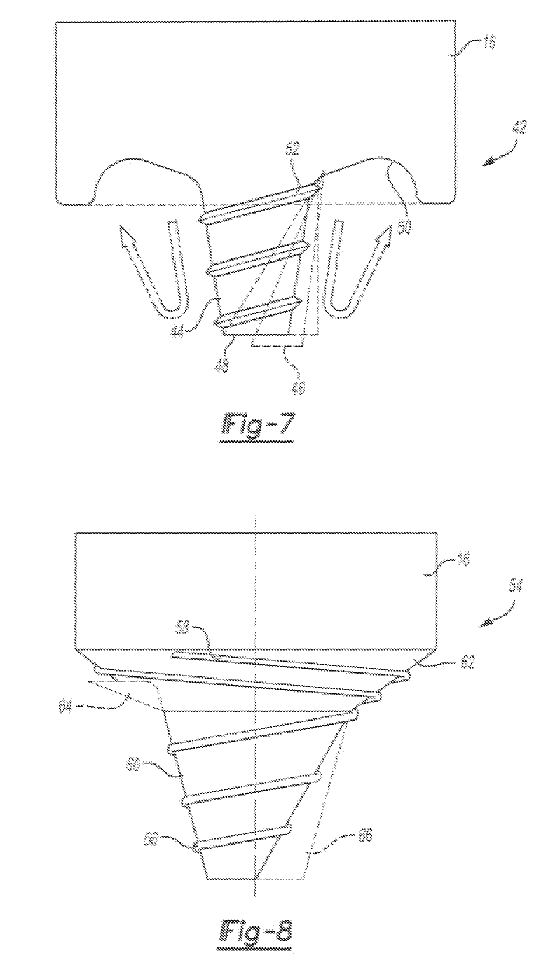

In another variation, referring to FIGS. 6A and 6B, a quasi-axial dual pin method is used where a device 36 includes one pin that runs inside of another. That is, the device is configured to include a ring-shaped pin 38 and a smaller pin 40 that fits within the ring-shaped pin 38. The revolutions and direction of rotation for each pin can be selected independently. The depth of the ring-shaped pin 38 may also be set at a depth that is less than a depth of the center pin 40. In this manner, the upper substrate 12 is plasticized when engaged by the upper pin 38 such that when the center pin 40 engages the lower substrate 14, the plasticized upper substrate 12 is easily commingles with the lower substrate 14 to form a plurality of interlocks 28 that run along the length of the weld in the weld direction. Quasi-axial pins 36 may also be used for each of the pins described above in the dual and triple-pin methods, as well as the cone stir process.

In another embodiment of the present teachings, a single friction stir welding device 42 having a pin 44 with a non-axisymmetric cut as illustrated in FIG. 7 may be used to form the plurality of interlocks 28 that connect the substrates 12 and 14 together. Referring to FIG. 7, the friction stir welding device 42 has a non-symmetric pin 44. To provide the non-symmetric pin 44, the pin 44 is cut to remove a portion of the pin 44 and related threading. Here, two cuts are illustrated. The first cut is a partial-cut 46, and the second cut is a full-cut 48. The partial-cut 46 extends to a cord of the bottom pin face and the full-cut 48 extends all the way to the edge of pin bottom face. Although the shoulder 16 in FIG. 7 is configured to have a concave shape 50, it should be understood, however, that convex and flat-shaped shoulders 16 may also be used. Further, although only a single non-axisymmetrical cut pin 42 is needed to form the plurality of interlocks 28 shown in FIG. 4, a plurality of these pins may be used.

The non-axisymmetric pin 42 may also be used in both the spot welding and linear stitch welding methods described above. The non-axisymmetric cuts 46 and 48 primarily bring two benefits. First, the cuts 46 and 48 greatly reduce a clogging problem by providing more outlets for the thread grooves 52 and enable a self-cleaning action to these grooves 52 due to larger friction force on the pin surface. Secondly, the non-axisymmetric cuts 46 and 48 provide a larger sideways pushing action, which is desired for generating a locking structure in both the cone stir scenario and the stitch welding scenario, addressed above. Additionally, it has been determined that a partial-cut 46 of the pin provides good performance in the cone stir application and a full cut 46 of the pin provides good performance in the linear stitch welding applications, although the present teachings should not be limited to these scenarios.

For spot welding, the non-axisymmetric cuts 46 and 48 are employed to generate a force for pushing material sideways at the bottom part of the weld when the pin 42 rotates. The sideways movement of the material is constrained by the pin shoulder 16 and the lateral non-deformed material (i.e., non-plasticized) so that the material changes deformation direction and moves upward as shown by the arrows in FIG. 7. In FIG. 7, the pin 42 rotates in a direction that corresponds to the thread orientation to push the material immediately adjacent to the pin downward. For linear stitch welding, the non-symmetric cuts 46 and 48 are intended to generate a laminated layer with the plurality of interlocks 28 shown in FIG. 4.

Another pin design that may be used in conjunction with the present teachings is an opposed thread pin 54. This pin 54 is particularly advantageous when joining a plurality of sheets together. The pin 54, as shown in FIG. 8, has two sets of threads 56 and 58. A right-hand thread 56 is present at the bottom 60 of the pin 54, and a left-hand thread 58 is present at the top 62 of the pin 54. When the pin 54 rotates clockwise, the bottom thread 56 pushes the material upward and the top thread 58 pushes the material downward. Further, the revolved cut 64 on top and the plane cut 66 on the bottom are designed to accommodate the materials being pushed around. The plane cut 66 may be a non-axisymmetric cut like those described above.

It should be understood that the motion of the material during the friction stir welding processes described above is important to providing a solid inter-lock between the substrates 12 and 14 to be joined. Accordingly, the present teachings provide for a spot welding method where the device 10 is tilted and moved through a plurality of points that make a conical shape 22 and 26; a linear stitch welding method where a plurality of pins 32 and 34 are used to manipulate the flow of the plasticized material 35; a non-axisymmetric pin 42 that assists in pushing material in predetermined directions; and a dual-threaded pin 54 with opposing threads 56 and 58. Yet another way to manipulate the flow of material in predetermined directions is to use an anvil 68 with a protruding annular ring 70.

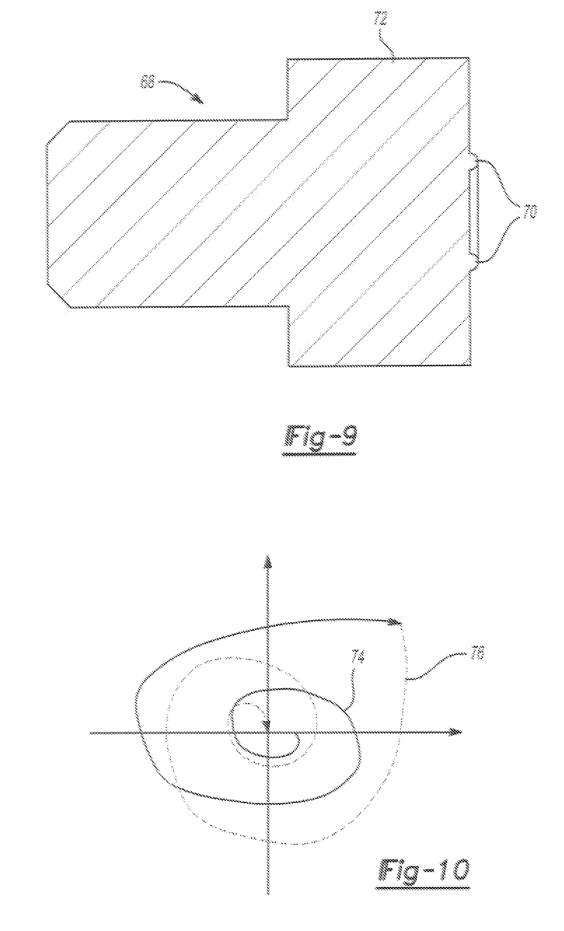

Referring to FIG. 9, the anvil 68 includes a round base portion 72 and a protruding ring 70 that extends from the base portion 72. Due to the annular ring 70, when the substrates 12 and 14 are placed on the anvil 68 and joined by a friction stir welding device, the annular ring 70 persuades the motion of the plasticized material 35 in a predetermined motion determined by a shape of the annular ring 70 that is beneficial to forming the connecting structure of interlocks 28. In other words, if a pin is used with a shoulder and thread that pushes material downwards toward the anvil 68, the ring 70 will force this material through a motion that is determined by a geometry of the ring 70.

Lastly, the present teachings provide a friction stir-based welding method that can create a patch-like joined area by sweeping a friction stir welding device 10 through a single or multiple spiral pattern 74 and 76 that enables formation of the interlocks 28 that are hook-shaped (i.e., the interlocks 28 shown in FIG. 2). In this regard, the device 10 is engaged to the substrates 12 and 14 at a position that corresponds to the origin of the axes depicted in FIG. 10. Then, the device 10 is moved such to follow the outward spiraling pattern 74 shown by the solid line. After following the outward spiraling pattern 74 that takes the device 10 away from the origin, the device 10 begins to follow the inward spiraling pattern 76 that brings the device 10 back to the origin. By moving the device 10 in this manner, the material of the substrates 12 and 14 is sufficiently plasticized and commingled to form the interlocks 28 that sufficiently interlock the substrates 12 and 14 together.

It should be understood that the device 10 may have an orthogonal orientation to the substrates 12 and 14 when following the spiral patterns 74 and 76. Notwithstanding, the device 10 may be tilted in any direction to assist in following the spiral patterns 74 and 76 or to sufficiently commingle the materials of the substrates 12 and 14 to form the interlocks 28. Further, although this embodiment has been described using the schematic friction stir welding device 10 shown in FIG. 1, it should be understood that any of the friction stir welding devices described in each of the above embodiments may be used interchangeably in each embodiment described.

Further, although the above method describes sweeping the device 10 through a first spiral pattern 74 and then a second spiral pattern 76 to form the interlocks 28, the present teachings should not be limited thereto. That is, the interlocks 28 may be formed simply by using the single spiral pattern 74 where the device 10 is engaged to the substrates 12 and 14 at the origin and swept along the spiral pattern 74 away from the origin. Moreover, the interlocks 28 may be formed simply by using the single spiral pattern 76. In this regard, the device 10 is engaged to the substrates 12 and 14 at a point away from the origin and then swept through the spiral pattern 76 to return to the origin.

Another pattern that is contemplated is that the device 10 is engaged to the substrates 12 and 14 at a point away from the origin, swept through a circular pattern about the origin, and then spirally swept from the circular pattern towards the origin. Regardless of the pattern chosen, it should be understood that substrates 12 and 14 are sufficiently plasticized in manner that the mechanical interlocking structure 28 is formed between the substrates 12 and 14 to provide a robust joint.

The description of the present teachings is merely exemplary in nature and, thus, variations that do not depart from the gist of the present teachings are intended to be within the scope of the invention. Such variations are not to be regarded as a departure from the spirit and scope of the present teachings.

What is claimed is:

1. A welding method, comprising:
providing a pair of substrates;
engaging a friction stir welding device to said pair of substrates; and
moving said friction stir welding device through a plurality of points as said device engages said substrates, said plurality of points forming an essentially conical shape.

2. The welding method according to claim 1, further comprising moving said friction stir welding device through another plurality of points as said device engages said substrates, said plurality of points forming an essentially inverse-conical shape.

3. The welding method according to claim 1, wherein said substrates are formed of the same material.

4. The welding method according to claim 1, wherein said substrates are formed of dissimilar materials.

5. The welding method according to claim 1, further comprising pre-heating said substrates.

6. The welding method according to claim 1, wherein said friction stir welding device includes a shoulder and a pin, said pin having a surface that is cut non-axisymmetrically.

7. The welding method according to claim 6, wherein said pin having said surface that is cut non-axisymmetrically is fully cut or partially-cut.

8. The welding method according to claim 6, wherein said shoulder has at least one of a concave, convex, or flat surface.

9. The welding method according to claim 1, wherein said friction stir welding device includes a shoulder and a pin, said shoulder including a first thread in a first direction and said pin including a second thread traveling in a second and different direction.

10. The welding method according to claim 1, wherein said moving said friction stir welding device through said plurality of points that is essentially conical in shape enables formation of a plurality of interlocks at an interface of said substrates that join said substrates together.

11. The welding method according to claim 1, further comprising disposing the substrates between an anvil including an annular protrusion and said friction stir welding device, said annular protrusion controlling a flow of plasticized material of said substrates during engagement of said friction stir welding device to said substrates.

12. A welding method comprising:
providing a pair of substrates;
engaging a plurality of friction stir welding devices to said substrates; and
moving said plurality of friction stir welding devices in a welding direction,
wherein at least one friction stir welding device has a diameter that is larger than a diameter of the other friction stir welding devices.

13. The welding method according to claim 12, wherein said substrates are formed of dissimilar materials.

14. The welding method according to claim 12, wherein said friction stir welding devices each include a pin having a surface that is cut non-axisymmetrically.

15. The welding method according to claim 12, wherein said friction stir welding devices rotate in the same direction.

16. The welding method according to claim 12, wherein said friction stir welding devices rotate in different directions.

17. The welding method according to claim 12, wherein said friction stir welding device having said larger diameter is a leading welding device and said friction stir welding devices having a smaller diameter are trailing devices.

18. A welding method comprising:
providing a pair of substrates;
engaging a friction stir welding device to said pair of substrates; and
moving said friction stir welding device through a substantially spiral path away from a point where said device initially engaged said substrates as said devices engages said substrates.

19. The welding method according to claim 18, further comprising moving said friction stir welding device through another substantially spiral path as said device engages said substrates, said another substantially spiral path returning said friction stir welding device to said point where said friction stir welding device initially engaged said substrates.

20. The welding method according to claim 19, wherein said spiral paths enable formation of a plurality of interlocks at an interface of said substrates that join said substrates together.
